(19) United States
(12) Patent Application Publication
(10) Pub. No.: US 2007/0023965 A1
(43) Pub. Date: Feb. 1, 2007

(54) STAGED COMPRESSION MOLDING PROCESS

(75) Inventor: Brett Kaufman, Newburgh, IN (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 11/531,660

(22) Filed: Sep. 13, 2006

Related U.S. Application Data
(63) Continuation-in-part of application No. 10/947,749, filed on Sep. 23, 2004, now Pat. No. 7,108,823.
(60) Provisional application No. 60/743,067, filed on Dec. 21, 2005.

(51) Int. Cl. B28B 3/02; B29C 67/24; B29C 43/02

(52) U.S. Cl. 264/319; 264/330

(57) ABSTRACT

A process of molding a container closure comprises depositing a gob of thermoplastics material in a mold cavity and then moving mold plates in an upper mold portion relative to an opposing lower mold portion to form the container closure in the mold cavity.

This application claims priority under 35 U.S.C. § 119(e) to U.S. Provisional Application Ser. No. 60/743,067, filed Dec. 21, 2005, and is a continuation-in-part of application Ser. No. 10/947,749, filed Sep. 23, 2004, both of which are expressly incorporated by reference herein.

### BACKGROUND

The present disclosure relates to compression molding processes. More particularly, the present disclosure relates to compression molding of plastics materials to produce container closures.

Compression molding of plastics materials typically entails forming a portion of raw material into a molded end-product such as a household item, for example. Compression molding methods are used to form thermosetting and thermoplastic resins to produce articles such as closures for containers.

### SUMMARY

In accordance with the present disclosure, a process of molding a container closure comprises depositing a gob of thermoplastics material into a mold cavity defined between upper and lower mold plates. The plates are moved relative to one another to form a monolithic container closure in the mold cavity. In illustrative embodiments, one upper mold plate is moved in stages relative to the lower mold plate to form a monolithic container closure in the mold cavity.

In illustrative embodiments, one mold plate is moved in a first stage to apply a low-pressure force to the gob in the mold cavity and then in a second stage to apply a relatively higher high-pressure force to the gob in the mold cavity. This process produces, in an illustrative embodiment, a monolithic container closure comprising a base adapted to mount on a container, a cap configured to mount on and close a discharge opening formed in the base, and a living hinge interconnecting the cap to the base.

Features of the process will become apparent to those skilled in the art upon consideration of the following detailed description exemplifying the best mode of the disclosure as presently perceived.

### BRIEF DESCRIPTION OF THE DRAWINGS

The detailed description particularly refers to the accompanying figures in which:

FIG. 1 is perspective view, with portions broken away, of a container carrying a monolithic container closure of the type made of a plastics material and formed by the staged compression molding process disclosed herein;

FIG. 2 is a sectional view of the closure of FIG. 1 taken generally along line 2-2 in FIG. 1 showing (from left to right) a lid, hinge, and cap included in the monolithic container closure;

FIG. 3 is a diagrammatic, sectional view, at time “0,” of a mold comprising an upper mold plate separated from and arranged to confront an underlying lower mold plate and showing a “gob” of thermoplastic material inserted into an interior region located between the upper and lower mold plates;

FIGS. 4 and 5 illustrate a molding sequence in accordance with the present disclosure;

FIG. 4 is a view similar to FIG. 3 showing a first stage of the molding process as low pressure is applied at time “T1” by the upper mold plate to a portion of the underlying thermoplastics material to cause the material to begin flowing across the face of the lower mold plate from a first region of a mold cavity provided in the mold into other regions of the mold cavity; and

FIG. 5 is a view similar to FIGS. 3 and 4 showing a second and final stage of the molding process wherein high pressure is applied by the upper mold plate at time “T2” to form the closure and to enhance physical properties of the monolithic container closure formed in the mold.

### DETAILED DESCRIPTION

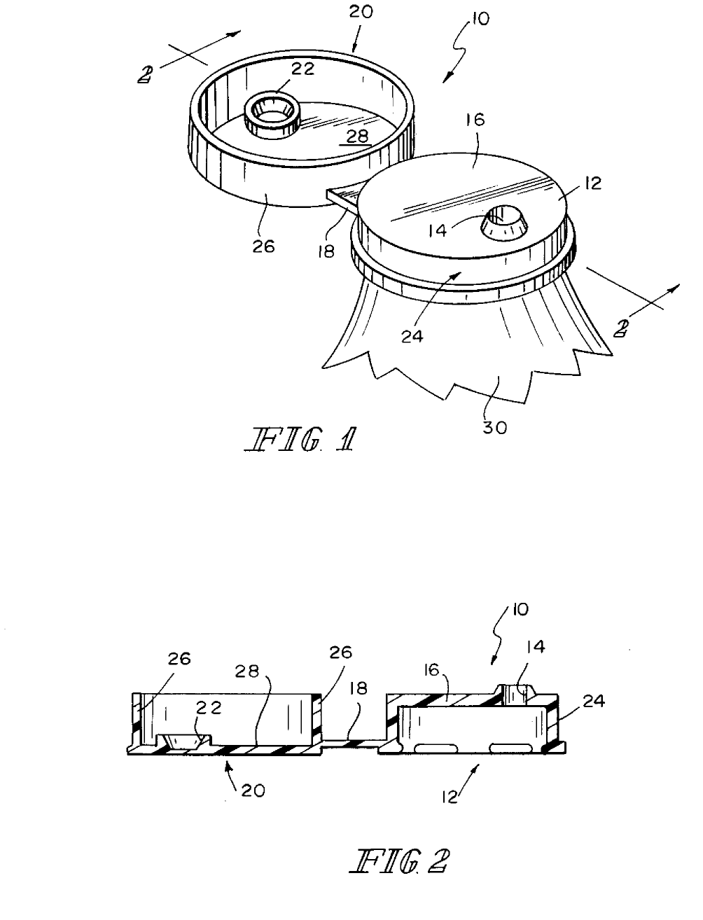

A container closure 10 includes a base 12 adapted to mount on a container 30, a hinge 18, and a cap 20 as shown, for example, in FIGS. 1 and 2. Base 12 is formed to include a discharge aperture 14 in a top wall 16. Cap 20 is formed to include a sealing dome 22 depending from a top wall 28, as shown, for example, in FIGS. 1 and 2. Base 12 includes an annular side wall 24 adapted to be coupled to an annular rim (not shown) of container 30. Cap 20 is adapted to be coupled to base 12 so that discharge aperture 14 is closed and sealed by sealing dome 22 when cap 20 is moved to a closed position (not shown) nesting on and mating with base 12. It is within the scope of this disclosure to vary the shape and geometry of the components which cooperate to effect the seal established at discharge aperture 14.

Closure 10 is monolithic and thus is formed as a single piece of compression-molded material, in three sections, to include a base 12, a cap 20, and a hinge 18 therebetween, as shown best in FIG. 1. Other shapes and geometries of closure 10 are within the scope of this disclosure.

Hinge 18 is coupled to side wall 24 of base 12 and side wall 26 of cap 20 to provide a “living” hinge. Hinge 18 is flexible to allow tethered movement of cap 20 relative to base 12. Upon completion of the staged compression molding process, base 12 can be of a greater mass than cap 29, which is of a greater mass than hinge 18.

In one embodiment of the staged compression molding process, a thermoplastics material is extruded and cut into a predetermined mass to form a pellet or gob 36 having any suitable shape. In an illustrative embodiment, gob 36 has an oval-shaped profile as suggested in FIG. 3. Gob 36 is then deposited into and arranged to lie in a mold cavity 38 provided in mold 40, as shown, for example, in FIG. 3. A gob molding sequence is illustrated in FIGS. 3-5 showing various stages of manipulating gob 36 to form container closure 10. Although in the illustrated embodiments, the gob is placed on a “core side” of the mold rather than in the opposing “cavity side” of the mold, it is within the scope of this disclosure to orient the mold so that the gob is placed in the cavity side of the mold before the molding process is initiated.

Mold 40 includes an upper mold plate 41 and a lower mold plate 42 as suggested in FIG. 3. Upper and lower mold plates 41, 42 cooperate to define an interior region or mold cavity 38 therebetween. Upper mold plate 41 is supported to move downwardly in direction 11 to within a predetermined distance of lower mold plate 42 as suggested, for example, in FIG. 5 to compress thermoplastics material associated with gob 36 placed in mold cavity 38 to produce a container closure 10 having a desired shape and thickness.

Upper mold plate 41 includes a first mold section 31 associated with cap 20 and formed to include a top wall 50, a dome-forming cavity 48, and a side wall-forming cavity 46. A second mold section 32 of upper mold plate 41 is associated with hinge 18 and includes top wall 52. A third mold section 33 of upper mold plate 41 is associated with base 12 and includes annular side wall 43, a top wall 45, and a discharge aperture-forming cavity 44.

First mold section 31 is arranged to mate with lower mold plate 42 generally to form cap 20 in the compression molding process by pressing a gob 36 of thermoplastics material against lower mold plate 42 as shown, for example, in FIGS. 3-5. Second mold section 32 is arranged to form hinge 18 in the molding process by pressing a portion of gob 36 against lower mold plate 42. Third mold section 33 is arranged to mate with lower mold plate 42 to form base 12 in the molding process. Aperture-forming cavity 44 cooperates with plug 54 to form discharge aperture 14 in top wall 16 of base 12 as suggested, for example, in FIG. 5.

As shown, for example, in FIG. 3, gob 36 is deposited into mold cavity 38 located between spaced-apart upper and lower mold plates 41, 42 before the staged molding process, in accordance with this disclosure, is begun. It is within the scope of this disclosure to form gob 36 in any suitable shape and size.

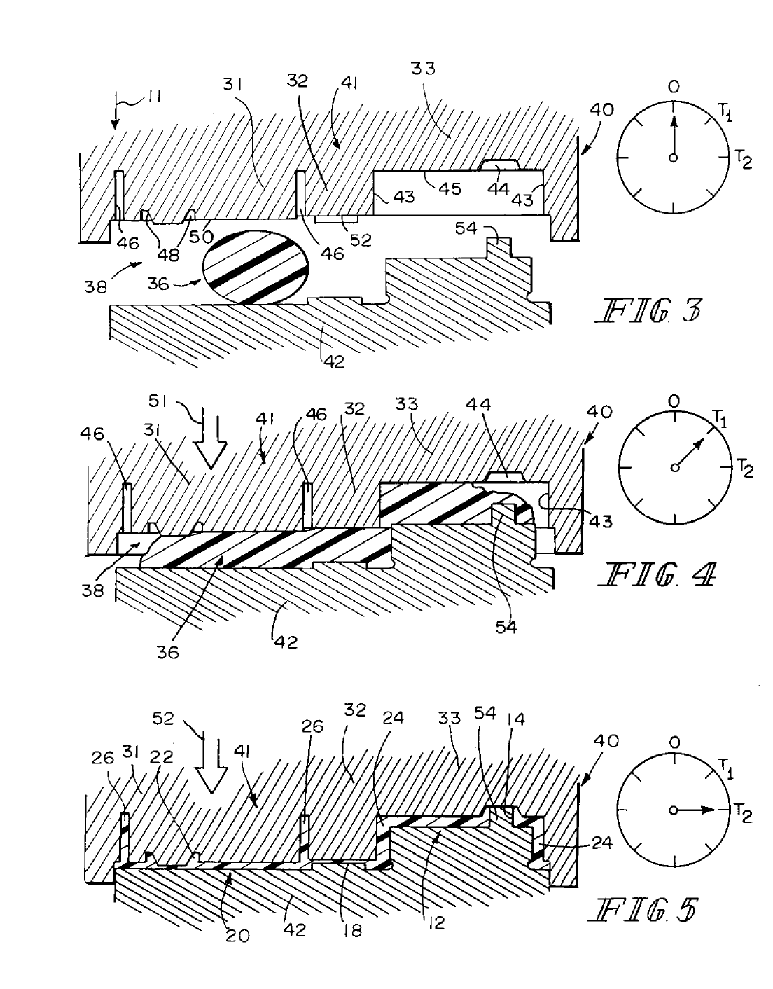

In stage one of the compression molding process, upper mold plate 41 is moved in direction 11 to apply a low-pressure compressive force 51, at time (T₁), to gob 36 as suggested in FIG. 4. Low-pressure compressive force 51 causes gob 36 to be compressed and flow through mold cavity 38 between upper and lower mold plates 41, 42 as suggested, for example, in FIG. 4. Low-pressure compressive force 51 compresses the gob between upper and lower mold plates 41, 42 during a first stage of the molding process to cause gob 36 to flow across mold plates 41, 42 and to allow gob 36 to fill in portions of mold cavity 38. Upper mold plate 41 remains in continuous contact with gob 36 as gob 36 flows across upper and lower mold plates 41, 42.

Stage two of the compression molding process begins at a later time (T₂) and begins with further movement of upper mold plate 41 in direction 11 to apply a high-pressure compressive force 52 to compress gob 36 further as suggested in FIG. 5 to cause gob 36 to fill mold cavity 38 so that the thermoplastics material attains the shape of container closure 10. Mold 40 is configured as needed to manage flow of gob 36 during relative movement of upper and lower mold plates 41, 42 so that plastics material does not “flash over” the top of plug 54 to cover the opening into discharge aperture 14 formed in top wall 16 of closure 10. High-pressure compressive force 52 is greater than low-pressure force 51 and causes further compression of the thermoplastics material in mold cavity 38 of mold 40 so that thermoplastics material 36 attains the desired shape of the end product, as for example, container closure 10 in the illustrated embodiment.

In an illustrative example in accordance with the present disclosure, the end of an extruder used to form gob 36 is formed on an angle as gob 36 is cut, making one side of gob 36 thinner than the other to provide gob 36 with a somewhat oval-shaped profile. In this particular example, the time interval between time T₂ and time T₁ is about 200 to 500 milliseconds and, at time T₂, the upper mold plate 41 is located about four millimeters before the “upper dead end” of the molding stroke.

1. A process of molding a container closure in stages, the process comprising
depositing a gob of thermoplastics material into a mold cavity located between spaced-apart upper and lower mold plates,
moving the upper mold plate at a first time (T₁) toward the lower mold plate to apply a low-pressure compressive force to the gob to compress the gob between the upper and lower mold plates during a first stage of the molding process to cause the gob to flow across the mold plates and to allow the gob to fill in portions of the mold cavity, wherein the upper mold plate remains in continuous contact with the gob as the gob flows across the upper and lower mold plates,
moving the upper mold plate at a later second time (T₂) further toward the lower mold plate and apply a high-pressure compressive force that is higher than the low-pressure compressive force to compress the gob therebetween during a second stage of the molding process to cause the gob to fill the mold cavity so that the thermoplastics material attains the shape of the container closure, and
moving the upper mold plate at a later third time (T₃) away from the lower mold plate to permit removal of the container closure from the mold.

2. The process of claim 1, wherein the container closure formed between the upper and lower mold plates during the molding process is monolithic and includes a cap formed between a first mold section of the upper mold plate and the lower mold plate, a base adapted to mount on a container and formed between a third mold section of the upper mold plate and the lower mold plate, and a living hinge arranged to interconnect the base and the cap and formed between a second mold section of the upper mold plate and the lower mold plate.

3. The process of claim 1, wherein the gob has an oval-shaped profile.

4. The process of claim 1, wherein a portion of the gob is placed under first and second mold sections of the upper mold plate before the upper mold plate is moved toward the lower mold plate during the first time (T₁) of the molding process.

5. The process of claim 4, wherein another portion of the gob is placed under a third mold section of the upper mold plate before the upper mold plate is moved toward the lower mold plate during the first time (T₁) of the molding process.

6. The process of claim 1, wherein the upper mold plate includes an aperture-forming cavity that cooperates with a plug formed in the lower mold plate to form a discharge aperture in the container closure.

7. The process of claim 2, wherein the first mold section is formed to include a top wall, a dome-forming cavity, and a side wall-forming cavity.

8. The process of claim 2, wherein the second mold section is formed to include a top wall.

9. The process of claim 2, wherein the third mold section is formed to include an annular side wall, a top wall, and a discharge aperture-forming cavity.

10. A process of molding a container closure in stages, the process comprising
depositing a gob of thermoplastics material into a mold cavity located between spaced-apart upper and lower mold plates, the upper mold plate including a first mold section to form a first portion of the container closure, a second mold section to form a second portion of the container closure and a third mold section to form a third portion of the container closure,
moving the upper mold plate at a first time (T₁) toward the lower mold plate to apply a low-pressure compressive force to the gob to compress the gob therebetween during a first stage of the molding process to cause the gob to flow across the mold sections,
moving the upper mold plate at a later second time (T₂) further toward the lower mold plate to apply a high-pressure compressive force that is higher than the low-pressure compressive force to compress the gob therebetween during a second stage of the molding process so that the thermoplastics material attains the shape of the container closure, and
moving the upper mold plate at a later third time (T₃) away from the lower mold plate to permit removal of the container closure from the mold.

11. The process of claim 10, wherein the gob is compressed between the first mold section and the lower mold plate to form a cap, between the second mold section and the lower mold plate to form a base, and between the third mold section and the lower mold plate to form a living hinge arranged to interconnect the base and the cap to provide a monolithic container closure comprising the cap, base, and living hinge.

12. The process of claim 10, wherein the gob has an oval-shaped profile.

13. The process of claim 10, wherein a portion of the gob is placed under the first and second mold sections before the upper mold plate is moved toward the lower mold plate during the first stage of the molding process.

14. The process of claim 13, wherein another portion of the gob is placed under the third mold section before the upper mold plate is moved toward the lower mold plate during the first stage of the molding process.

15. The process of claim 10, wherein the first mold section is formed to include a top wall, a dome-forming cavity, and a side wall-forming cavity.

16. The process of claim 10, wherein the second mold section is formed to include a top wall.

17. The process of claim 10, wherein the third mold section is formed to include an annular side wall, a top wall, and a discharge aperture-forming cavity.

18. A process of molding a container closure in stages, the process comprising
depositing a gob of thermoplastics material into a mold cavity located between spaced-apart upper and lower mold plates,
moving the upper mold plate at a first time (T₁) toward the lower mold plate to apply a low-pressure compressive force to the gob to compress the gob therebetween during a first stage of the molding process to cause the gob to flow across the mold plates, and
moving the upper mold plate at a later second time (T₂) further toward the lower mold plate to apply a high-pressure compressive force that is higher than the low-pressure compressive force to compress the gob therebetween during a second stage of the molding process so that the thermoplastics material attains the shape of the container closure.

19. The process of claim 18, wherein the container closure formed between the upper and lower mold plates during the molding process is monolithic and includes a cap formed between a first mold section of the upper mold plate and the lower mold plate, a base adapted to mount on a container and formed between a third mold section of the upper mold plate and the lower mold plate, and a living hinge arranged to interconnect the base and the cap and formed between a second mold section of the upper mold plate and the lower mold plate.

20. The process of claim 18, wherein the gob has an oval-shaped profile.

21. The process of claim 19, wherein a portion of the gob is placed under the first and second mold sections before the upper mold plate is moved toward the lower mold plate during the first stage of the molding process.

22. The process of claim 21, wherein another portion of the gob is placed under the third mold section before the upper mold plate is moved toward the lower mold plate during the first stage of the molding process.

23. The process of claim 19, wherein the first mold section is formed to include a top wall, a dome-forming cavity, and a side wall-forming cavity.

24. The process of claim 19, wherein the second mold section is formed to include a top wall.

25. The process of claim 19, wherein the third mold section is formed to include an annular side wall, a top wall, and a discharge aperture-forming cavity.
